(19) United States
(12) Patent Application Publication
(10) Pub. No.: US 2015/0078228 A1
(43) Pub. Date: Mar. 19, 2015

(54) Method for Processing the Reception of a Communication Signal by Radio Channel, and Associated Method for Processing the Transmission, Devices and Computer Programs

(71) Applicant: ORANGE, Paris (FR)

(72) Inventors: Jean Schwoerer, Grenoble (FR); Benoît Miscopein, Grenoble (FR)

(73) Assignee: ORANGE, Paris (FR)

(21) Appl. No.: 14/387,772

(22) PCT Filed: Mar. 28, 2013
(86) PCT No.: PCT/FR2013/050676

§ 371 Date: Sep. 24, 2014

(30) Foreign Application Priority Data
Mar. 29, 2012 (FR) 1252814

(51) Int. Cl. H04W 52/02; H04W 72/04

(52) U.S. Cl. CPC H04W 52/0209; H04W 72/04
USPC 370/311

(57) ABSTRACT

Provided are methods for receiving and transmitting a communication signal by radio channel and corresponding devices and computer programs. A plurality of nodes alternately comply with sleep periods and wake periods, and a transmitter node precedes transmission of data to a recipient node with a step of transmitting a preamble of a length at least equal to a sleep period of the recipient node, wherein at least two transmission channels has been defined between the nodes with a view to the transmission of the preamble. The method includes selecting from the plurality of channels at least one channel for listening to the preamble, called a current channel; and deciding to the change the listening channel on detection of at least one triggering event likely to affect predetermined operational constraints of the receiver node.

### 1. CROSS-REFERENCE TO RELATED APPLICATIONS

This application is a Section 371 National Stage Application of International Application No. PCT/FR2013/050676, filed Mar. 28, 2013, the content of which is incorporated herein by reference in its entirety, and published as WO 2013/144516 on Oct. 3, 2013, not in English.

### 2. FIELD OF THE INVENTION

The field of the invention is that of wireless radio telecommunications networks, and more particularly nodes of such a network, subject to energy consumption constraints, such as sensor nodes.

### 3. BACKGROUND

In order to reduce the energy consumption of a receiving node, it is known to subject it to an alternation of regularly spaced sleep periods T_{S} and wake periods T_{W}. The higher the T_{S}/T_{W} ratio, the more substantial the energy saving achieved.

In applications requiring sensors with energy autonomy, this sleep period may last several seconds, whereas the wake period is extremely short. A sleep period in the order of T_{S}=1 second and a wake period in the order of T_{W}=50 μs can be taken as an example.

On the other hand, the receiving node becomes incapable of detecting a data signal received during a sleep period, since it is then inactive.

This problem is generally resolved in two ways:
either by synchronizing the entire network, in such a way that each node is active, i.e. awake, at the same time. A disadvantage is that this produces a regular and burdensome, i.e. energy-consuming, signaling;
or by causing the data signal to be preceded by a wake-up preamble, with a duration T_{P} greater than or equal to the duration of a complete cycle Cy=T_{S}+T_{W} of the receiving node, in such a way as to alert the node to the arrival of data. However, the duration of a sleep period being generally much greater than that of a wake period, it can be assumed that it is sufficient to satisfy the following inequality: T_{P}>T_{S}, in order to be guaranteed that the node necessarily wakes up during the transmission of this preamble. This solution offers the advantage of being totally asynchronous and of not generating any signaling traffic.

### 4. DISADVANTAGES OF THE PRIOR ART

This second option is often chosen due to the simplicity of its implementation. However, it suffers from one major disadvantage: the very short wake-up period of the receiver is a time of high vulnerability.

In fact, if any phenomenon whatsoever occurs during this brief time, for example interference (or “fading” in English), the receiver does not detect the preamble announcing the data intended for it and they are entirely lost.

Furthermore, given the absence of coordination between the transmitter and the receiver, the preamble listening period necessarily takes place on the same radio channel, the only channel for the entire network, the signaling channel. If this channel suffers from constant interference, communication with the nodes affected by the interference is no longer possible.

While the transmission of the useful part of the frame can benefit from an error correction and/or a diversity, for example using a frequency hopping transmission method in order to correct the impact of the interference or fading, the transmission of the preamble is not in itself protected in any way.

Despite its length, the transmission of the preamble is therefore more fragile than that of the useful data.

### 5. SUMMARY

An aspect of the present application relates to a method for processing the reception of a communication signal in a communication network including a plurality of nodes alternately observing sleep periods and wake periods, a transmitting node causing the data transmission to a destination node to be preceded by a step of transmitting a preamble with a duration greater than a sleep period of the destination node.

According to the invention, a plurality of at least two transmission channels having been defined between the nodes with a view to transmitting said preamble, said method includes the following steps:
selecting, from the plurality of channels, at least one preamble listening channel, referred to as the current channel;
deciding to change listening channels from the plurality of transmission channels on detection of at least one triggering event likely to affect predetermined operating constraints of said receiving node.

According to the invention, a receiving node selects the transmission channel that it will listen to and it can decide to change transmission channels on detection of a triggering event likely to affect its operation.

Thus, the invention is based on an entirely novel and inventive approach to the transmission of a transmission signal. In fact, it provides the receiving node with the autonomy necessary for deciding unilaterally to change signaling channels when it deems it to be necessary. This allows it to satisfy its own operating constraints, without generating additional signaling and therefore without affecting the transmitter.

According to one aspect of the invention, said at least one triggering event belongs to the group including at least:
a noise level greater than a predetermined noise threshold;
a start of a new wake period.

The triggering events listed are linked to operating constraints of the receiving node. More precisely, such events prevent compliance with these constraints.

The constraints considered also include quality of service constraints, such as the security of the transmission channel or the reception quality it provides, and also constraints relating to the management of the energy resources of the receiving node.

The consideration of a time constraint which imposes a change of signaling channel with each wake-up period notably enables the security of the transmission to be increased.

Compliance with a constraint relating to the level of noise detected on the signaling channel guarantees a quality level for the preamble reception, while conserving the energy resources of the receiving node. In fact, a receiving node expends resources unnecessarily when it has to process a substantial quantity of noise on the signaling channel. The value of the noise threshold obviously varies according to the characteristics of the network and the transmission mode used. According to a different aspect, the method according to the invention includes a step of determining a noise level, including the following steps:
receiving information relating to a detection of energy on the signaling channel, corresponding to a false detection of a communication signal;
counting a number of false detections by time unit; and
comparing the number of false detections counted with said noise threshold level;
and in that a triggering event is detected when said number of false detections is greater than said noise threshold.

A receiving node conventionally includes means for detecting the energy of the signals received on the signaling channel and means for processing the detected energy with a view to evaluating whether a communication signal or, on the contrary, a false detection is actually involved.

The invention proposes to use the information supplied by such energy detection means to determine a noise level present on the signaling channel. When the number of false detections processed by time unit exceeds a predetermined threshold, the value of which depends at least on the application and the transmission mode used, the receiving node assumes that the signaling channel has a noise level that is too high to comply with the operating constraints that it has imposed on itself. It is therefore in the presence of an event triggering a change of preamble listening channel.

According to a different aspect, the receiving node and the destination node having defined a main channel among the plurality of channels, said main channel is selected as the preamble listening channel and the channel-changing step is triggered only if a noise level greater than the predetermined noise threshold is detected.

In this first embodiment of the invention, the transmitting and receiving nodes have agreed on the use of a transmission channel as the main signaling channel. The receiving node therefore decides to change signaling channels only in the event of an excessively high noise level, for example due to interference or fading.

A first advantage of this embodiment is to be simple, pragmatic and energy-saving for the receiving node, which does not expend its energy resources on changing transmission channels.

Another advantage of this embodiment is that it does not impose any extending of the duration of the preamble, since the receiving node operates under conditions similar to those of the prior art. This is highly advantageous in a normal situation, but causes an increased latency in the event of interference on the transmission channel.

This first embodiment is therefore well-suited to networks carrying heavy traffic or operating in an environment rarely affected by interference.

According to a different aspect, a decision to change channels is triggered with each start of a new wake period and in that the transmission channel is selected from the N transmission channels according to a predetermined listening order.

In this second embodiment, the receiving node selects a new signaling channel with each start of a wake period. With each new wake period, it listens to a different channel of the plurality of channels, according to a predetermined listening order.

In order to guarantee that the receiving node listens to the preamble, its duration must be chosen to be at least equal to N compute cycles (T_{S}+T_{W}).

A first advantage of this embodiment is the protection of the transmission of the preamble, which is not transmitted each time on the same channel.

A second advantage is an improved responsiveness of the receiving node when the transmitting node transmits the preamble on a plurality of channels at once, since it listens periodically to each of the transmission channels defined with the other nodes of the network as potential signaling channels. This solution therefore offers the advantage of low latency, since, in the event of an interference-related transmission problem on the signaling channel, the time required for the transmitting and receiving nodes to be located on a different transmission channel is minimal.

This second embodiment maintains a system responsiveness that is unchanged compared with the prior art. Due to the long preamble, this embodiment of the invention is well-suited to networks with low traffic or operating under unstable conditions.

Advantageously, the receiving node observes an alternation of a wake period and a sleep period.

According to one variant, N successive wake periods follow N successive sleep periods. One advantage is that the receiving node listens to all the channels in succession during its long wake period.

The invention also relates to a device for processing the reception of a communication signal suitable for carrying out the method for processing the reception of a communication signal that has just been described.

This device will obviously be able to comprise the different characteristics relating to the method for processing the reception of a communication signal according to the invention.

Advantageously, a device of this type can be integrated into a receiving node.

The invention furthermore relates to a method for processing the transmission of a communication signal in a communication network including a plurality of nodes alternately observing sleep periods and wake periods, a transmitting node causing the transmission of data to at least one destination node to be preceded by a step of transmitting a preamble with a length at least equal to a sleep period of the destination node, characterized in that, a plurality N of at least two transmission channels having been defined between the transmitting node and said at least one destination node, said method includes the following steps:
selecting, from the defined plurality of N transmission channels, at least one channel for transmitting said preamble, referred to as the current channel;
deciding to change transmission channels on detection of a transmission event likely to affect predetermined operating constraints of said transmitting node on said at least one current channel.

A method of this type is intended to be carried out by a transmitting node.

With the invention, the transmitting note selects at least one transmission channel on which to transmit the preamble of the communication signal that it wishes to transmit to the destination node. Like the receiving node, it can decide to change transmission channels on detection of a triggering event.

Thus, the transmitting node itself also has a certain autonomy in order to ensure an optimum operation, notably in terms of energy resource management and quality of service.

According to one aspect of the invention, the transmission event belongs to the group including:
an absence of reception of an acknowledgement of receipt message at the end of a predetermined number of retransmissions of said preamble on said channel;
a detection of a noise level greater than a second predetermined noise threshold.

The triggering events include notably a repeated preamble transmission failure. The transmitting node infers such a failure when it has not received an acknowledgement of receipt message from the destination node at the end of a certain number of retransmissions of the preamble on the same channel. It then assumes that it is expending energy unnecessarily in attempting to communicate with the destination node on a transmission channel to which it is not listening and decides to switch over to a different transmission channel. The invention thus allows it to optimize the consumption of its energy resources while guaranteeing the quality of service.

Another triggering event relates to the level of noise present on the current transmission channel. According to the invention, when it exceeds a predetermined noise threshold, the transmitting node assumes that the security of the preamble transmission is no longer guaranteed on this channel and it initiates a change of transmission channel for the preamble transmission. This allows the transmitting node to maintain the quality of service and the security of the communication with the destination node.

According to another different aspect, the transmitting node having previously defined a main transmission channel with the receiving node, said main channel is selected as the listening channel.

According to this embodiment of the invention, the transmitting node still transmits the preamble on the same transmission channel and only changes when a transmission event likely to jeopardize its transmission constraints occurs. One advantage of this embodiment is to be simple, pragmatic and energy-saving.

According to a different aspect, the selection step consists in selecting the plurality of transmission channels for a simultaneous transmission of the preamble on the plurality of channels and in that, on detection of a transmission event on one of said channels, the step of deciding to change channels decides to stop the transmission of the preamble on said channel.

According to this embodiment of the invention, the transmitting node begins by transmitting simultaneously on the plurality of channels defined with the receiving node. It can decide to stop transmitting on one of the channels on detection of a transmission event.

A transmitting node of this type therefore necessarily has transmission capacities and consequently energy resources greater than those of a conventional sensor node, which can transmit on only one transmission channel at a time.

This embodiment advantageously applies to a transmitting node which intends to transmit a communication signal to a plurality of destination nodes. A concentrator node suitable for collecting the measurement signals from a plurality of sensor nodes is taken as an example. A node of this type can be made to transmit data, for example control messages to a plurality of sensor nodes, said messages including physical data collection instructions.

One advantage of this embodiment is that it allows the transmitting node to reach all of the destination nodes according to the invention as quickly as possible. In fact, not knowing which transmission channel they are currently listening to, it is expedient for it to transmit simultaneously on all of the channels.

Another advantage of this embodiment is that it gives the transmitting node the opportunity to stop the transmission on a transmission channel which no longer complies with the operating constraints, for example because it is noisy. Thus, it does not expend its energy resources unnecessarily and ensures the security of the data which it transmits.

The invention furthermore relates to a device for processing the transmission of a communication signal suitable for carrying out the transmission method that has just been described.

This device will obviously be able to comprise the different characteristics relating to the method for processing the transmission of a communication signal according to the invention.

The invention also relates to a node including a transmission device and a reception device according to the invention.

The invention furthermore relates to a communication network including at least two nodes according to the invention.

According to one variant, a network of this type includes a node according to the invention, furthermore suitable for transmitting simultaneously on the plurality of channels. The node is, for example, a concentrator node.

The invention also relates to a computer program comprising instructions for carrying out a method for processing the reception of a communication signal as previously described, when this program is run by a processor. A program of this type can use any programming language. It can be downloaded from a communication network and/or recorded on a computer-readable medium.

The invention finally relates to a computer program comprising instructions for carrying out a method for processing the transmission of a communication signal as previously described, when this program is run by a processor. A program of this type can use any programming language. It can be downloaded from a communication network and/or recorded on a computer-readable medium.

### 6. LIST OF FIGURES

Other advantages and characteristics of the invention will become clearer from a reading of the following description of a particular embodiment of the invention, given by way of a simple, illustrative and non-limiting example, and the attached drawings, in which:

FIG. 1 shows schematically a radiocommunication network including a plurality of nodes according to the invention;

FIG. 2 shows schematically the steps of the method for receiving a communication signal in such a network according to the invention;

FIG. 3 shows schematically the steps of the method for transmitting a communication signal in such a network according to the invention;

FIGS. 4A, 4B and 4C show three embodiments of channel listening alternation according to the invention;

FIG. 5 shows schematically the exchanges between a transmitting node and a receiving node according to a first embodiment of the invention;

FIG. 6 shows schematically the exchanges between a transmitting node and a receiving node according to a second embodiment of the invention;

FIG. 7 shows schematically the exchanges between a transmitting node and a receiving node according to a third embodiment of the invention;

FIG. 8 shows an example of the structure of a transmitting/receiving node, including a communication signal transmission device and a reception device according to the invention.

### 7. DESCRIPTION OF A PARTICULAR EMBODIMENT OF THE INVENTION

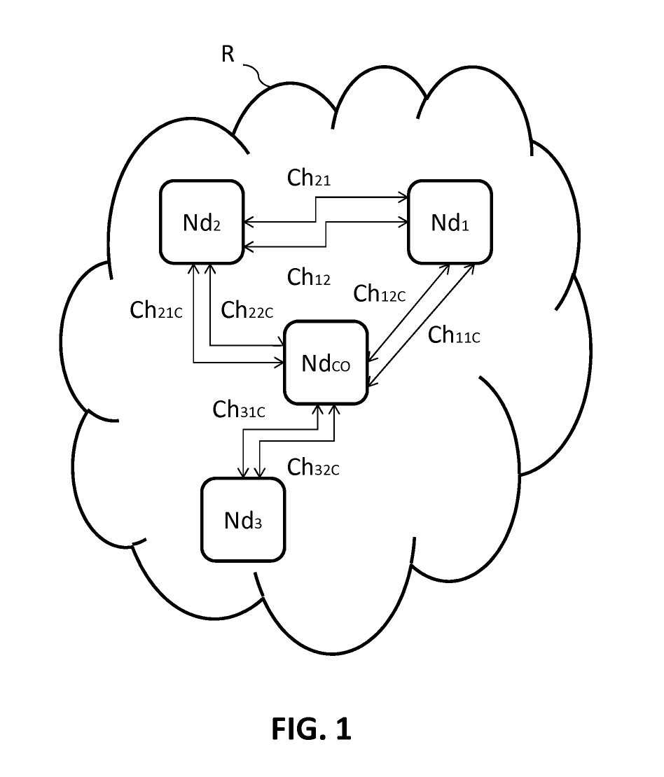

In relation to FIG. 1, a radiocommunication network R is considered, including a plurality of nodes Nd1, Nd2, Nd3 subject to energy consumption constraints. This involves, for example, sensors suitable for carrying out physical measurements of their environment and transmitting them to a concentrator node Nd_{CO}.

The nodes Nd₁, Nd₂, Nd₃ of the network R communicate by radio channel, for example according to an “Ultra Wide Band”, UWB in English, technology.

The invention is obviously not limited to this example and applies to any communication between two nodes of a radiocommunication network according to a ZigBee technology or the like, provided that the nodes are subject to energy consumption constraints.

Such sensor nodes, which are generally battery-powered, may not be accessible for changing a battery, for example because they are buried, built into the walls of a building or installed on-board a vehicle. They must therefore be provided with the longest possible operating autonomy, by sparing the energy resources which their battery supplies to them. For this purpose, it is necessary to minimize the level of activity of the node, which entails keeping it switched off for most of the time.

As previously mentioned, the simplest solution for achieving this is to subject the node to an alternation of wake and sleep periods, the duration T_{W} of the wake period being minimal in relation to that of the sleep period T_{S}.

To recap, the general principle of the invention is based on the definition of a plurality of transmission channels between a transmitting node and a receiving node and on the possibility for a receiving node to change listening channels on detecting a triggering event likely to affect at least one of its operating constraints.

In the example shown in FIG. 1, two transmission channels Ch_{11c} and Ch_{12c} are considered, defined between the concentrator node Nd_{CO} and the sensor node Nd₁, two transmission channels Ch_{21c}, Ch_{22c} defined between the concentrator node Nd_{CO} and the sensor node Nd₂ and two transmission channels Ch_{31c} and Ch_{32c} defined between the concentrator node Nd_{CO} and the sensor node Nd₃. Two transmission channels Ch₁₂, Ch₂₂ between the sensor node Nd₁ and the sensor node Nd₂ are furthermore considered.

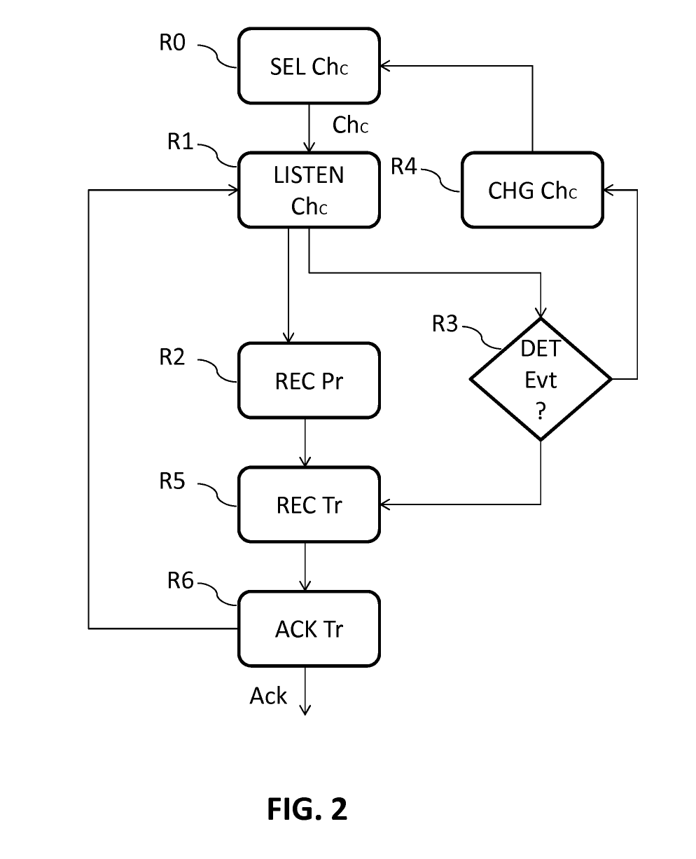

In relation to FIG. 2, the steps of the method for processing the reception of a communication signal by a receiving node B, for example Nd₁, Nd₂ or Nd₃, are now shown. The communication signal is transmitted by a transmitting node A, for example Nd_{CO} or Nd₁, to a receiving node.

In this example, N is taken as equal to 2 channels, this number achieving a good compromise between reliability and latency.

The node A must transmit a communication signal to the node B including a preamble Pr and a data frame Tr.

The node A and the node B are assumed to have previously defined N=2 transmission channels Ch₁, Ch₂ likely to be used as the signaling channel.

During a step R0, the receiving node B selects a transmission channel to be listened to from the channels Ch₁ and Ch₂ with a view to receiving a preamble Pr of a communication signal S. The selected channel, referred to as the current signaling channel Ch_{C}, is, for example, equal to Ch₁.

The receiving node B thus begins to listen to the channel Ch_{C} selected in R1. During a step R2, a preamble Pr is received on the current channel Ch_{C}. This reception step initiates the performance of a step R3 of detecting triggering events Evt likely to affect at least one predetermined operating constraint of the receiving node B.

The events taken into consideration may be of different types. They may involve simple time-based events which occur periodically, such as, for example, a start time of a new wake period for the transmitting node A. The node A is in fact subject to wake and sleep periods. A first operating constraint may be for it to change signaling channels with each new wake period, in such a way as to ensure increased resilience to interference.

By way of example, a second operating constraint relates to a noise threshold beyond which the main transmission channel is no longer deemed to satisfy the required conditions of quality of service and security for the transmission of a preamble. Such a step R3 then includes a step of detecting a level of noise received on the main channel, said step implementing energy detection means natively present in a node of a radiocommunication network. Such means, implemented in a wake period during the listening step, are suitable for detecting a quantity of energy received on the current channel and for comparing it with an energy threshold beyond which the radio reception means of the node are activated to search for a useful signal presence on the channel. The radio reception means are in fact natively configured to distinguish useful signals from false detections. It is thus possible to obtain information relating to a number of false detections received per time unit. During the step R3, this number is compared with a threshold number corresponding to said noise threshold.

False detections of this type may originate from other radio transmitting nodes which transmit on the same channel (intentional interference) or from interference signals generated by the activity of other nodes on adjacent transmission channels (unintentional interference).

When a triggering event Evt has actually been detected during the step R3, a change of signaling channels is decided by the receiving node B during a step R4. The new listening channel for the reception of a preamble is selected from the N transmission channels previously defined with the transmitting node A, according to a predetermined rule, during a new performance of the step R0. In the example considered, N being equal to 2, the new chosen current signaling channel is necessarily the channel Ch₂.

The performance of the method then resumes in the listening step R1, which is carried out this time on the channel Ch₁.

The case where no triggering event Evt is detected during the step R3 will now be considered. When the node B, following the reception of the preamble Pr, has established that the useful data of the communication signal S were intended for it, it initiates a step R5 of receiving the useful data frame Tr of the signal S on a channel Ch_{T} according to a transmission scheme previously defined between the node A and the node B.

It will be noted here that, in principle, the data frame is transmitted on the transmission channel to which the receiving node is listening, i.e. the channel Ch_{C}. However, if the data frame is transmitted according to a fast frequency hopping technique, the transmission of the Fame Tr will be able to start on the signaling channel Ch_{C} and continue on a sequence of transmission channels among the N channels defined between the transmitting and receiving nodes. It is also possible to dedicate a channel to the transmission of the useful data.

If the frame is not intended for it, the node B can decide to go back to sleep. At the end of this step R5, when it has taken place normally, an acknowledgement of receipt message Ack is transmitted by the node B, during a step R6, to the node A on the current signaling channel Ch_{c}.

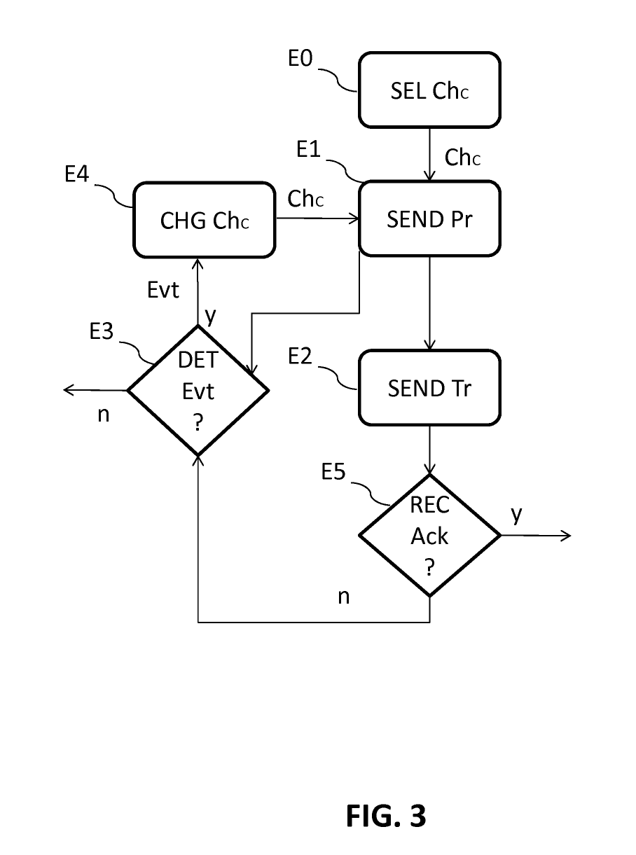

In relation to FIG. 3, the steps of the method for processing the transmission of a communication signal according to the invention are now shown.

During a step E0, the transmitting node A selects at least one transmission channel, referred to as the current signaling channel Ch_{c}, on which to transmit the preamble Pr. In E1, it transmits the preamble Pr to the node B on said at least one current channel Ch_{c}, for example equal to Ch₁.

During a step E2, the transmitting node causes the transmission of the preamble Pr to be followed by the transmission of the data frame Tr on a transmission channel Ch_{T} in accordance with a communication scheme previously defined with the destination node.

At the end of step E2, the method switches, in a step E5, to standby awaiting an acknowledgement of receipt message Ack from the destination node B, on the current signaling channel Ch_{C}.

In parallel with the steps E1, E2 and E5, the node A initiates a step E3 of detecting triggering events likely to affect at least one of its predetermined operating constraints. A step of this type is carried out in a manner similar to step R3 previously described for the reception method.

As far as the triggering events are concerned, at least two types can be assumed:
Events linked to the level of noise received on the current channel. A transmitting node is in fact generally a receiving node also. It therefore includes the energy detection means and the radio reception means previously described and natively integrated into its reception means. The transmitting node can therefore obtain from its reception means information relating to a number of false detections received per time unit on the current channel and can compare them with a noise threshold. If the noise threshold is exceeded, the quality of service can no longer be guaranteed on the current channel. It is appropriate to change channels;
Events linked to the reception of the data frame Tr by the destination node.

As long as the transmitting node has not received an acknowledgement of receipt message from the destination node, it cannot assume that the communication signal transmission has been successful. In this case, the associated operating constraint is therefore the absence of an acknowledgement of receipt message. In such a situation, it is probable that the receiving node has not received the preamble transmitted on the current channel. It is therefore appropriate to attempt to transmit to it on a different channel.

When a triggering event has been detected during the step E3, a decision to change signaling channels is taken in E4. A different transmission channel among the N channels defined with the destination node is chosen. In the particular example considered in FIG. 3, N being equal to 2, the chosen channel is necessarily the channel Ch₂.

When N is greater than 2, the transmitting and receiving nodes can advantageously agree in advance a transition sequence of the N transmission channels. The signaling channel selection step takes account of the agreed transition sequence.

The step E1 of transmitting the preamble is therefore carried out once more, this time on the current channel Ch_{c}=Ch₂.

When no triggering event Evt has been detected during the succession of steps E1, E2 and E5, no decision to change signaling channels is taken. The same channel is selected for the transmission of a subsequent preamble.

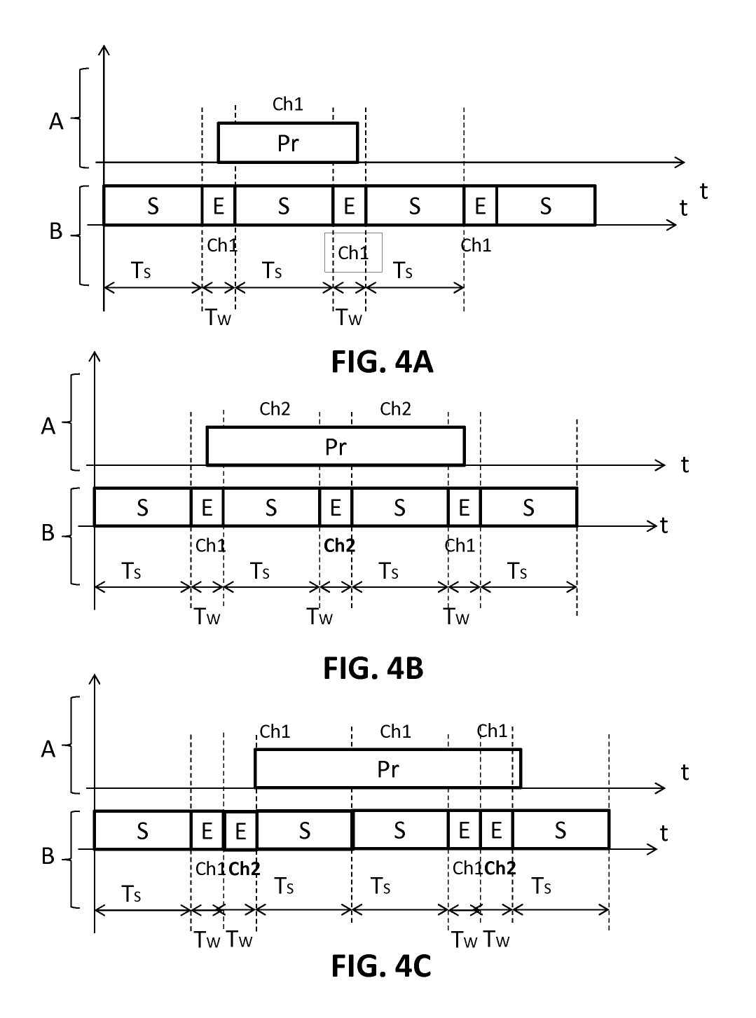

In relation to FIGS. 4A to 4C, three example embodiments are now shown of listening alternations on the N transmission channels defined by the nodes A and B, according to the invention.

In FIG. 4A, the node A and the node B have previously defined a main signaling channel Ch_{P} equal to Ch₁ and a secondary signaling channel equal to Ch₂. As a result, the node B listens preferentially to the signaling channel Ch_{P} and decides to change channels only on detection of a noise level higher than a predetermined noise threshold.

In the absence of a triggering event on the transmitting or receiving side, the communications between the nodes A and B therefore take place in a manner similar to those of the prior art.

As in the prior art, the result is that the node A transmits preambles with a duration T_{P} greater than a sleep period T_{S}. The duration of the preamble does not therefore need to be extended.

If an excessively high noise level has forced the node B to switch its listening over to the secondary channel before having received the preamble on the main signaling channel Ch_{P}, the node A will then have to retransmit the preamble on the secondary channel as soon as it has detected the absence of an acknowledgement of receipt message from the destination node B.

In FIG. 4B, the node B observes a listening alternation between the transmission channels Ch₁ and Ch₂ according to a period equal to a complete cycle Cy, including a sleep period S and a wake period E. With each new wake period, it selects a new signaling channel and therefore switches its listening from one transmission channel to the other.

As a result, in order to ensure that the node B wakes up during the transmission of the preamble Pr and listens to the current signaling channel selected by the node A, the node A must transmit a preamble with a duration at least equal to N complete cycles: Cy=T_{S}+T_{W}, i.e. T_{P}≧N. (T_{S}+T_{W}).

In relation to FIG. 4C, the node B observes a sequence of sleep and wake periods, including a sleep period S followed by N wake periods. During the N successive wake periods, it listens successively on the N transmission channels defined with the node A according to a predetermined transition sequence. The result for the node A is that the preamble which it transmits must have a length at least equal to two complete cycles, as in the preceding example.

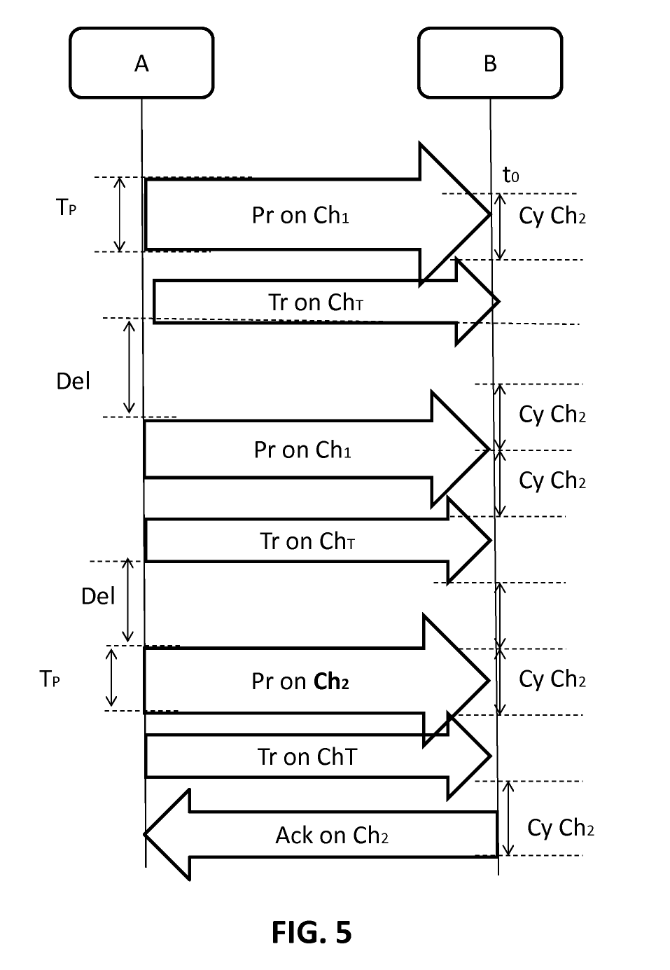

In relation to FIG. 5, a diagram is shown of the flows exchanged between the transmitting node A and the receiving node B according to a first embodiment of the invention.

In this example, the nodes A and B operate according to an exchange mode referred to as a peer-to-peer mode. This mode is particularly well-suited to two node devices, for example sensors, which have an equivalent level of resources, in terms of either energy, computing or radio transmission/reception capacities.

It is assumed that the nodes A and B have jointly defined a main signaling transmission channel Ch_{P} equal to Ch₁, but that, at least since the time to +T_{S}, the node B has decided to fall back onto the secondary channel Ch₂ following the detection of a triggering event Evt relating to an excessively high noise level on the channel ChP.

The node A, wishing to transmit a communication signal to the node B, ignores the channel change of the node B. It therefore selects the main signaling channel Ch_{P} and begins to transmit a preamble Pr on this channel, with a length T_{P} greater than T_{S}. It then transmits the data frame Tr on a transmission channel Ch_{T} in accordance with a transmission scheme defined with the node B.

It will be noted that this transmission channel is not necessarily the same as the signaling channel Ch_{P}. It is specified by the transmission scheme defined between the nodes and depends notably on the transmission mode used.

The node A switches to standby awaiting an acknowledgement of receipt message during a time period Del. Since the node B is listening to the transmission channel Ch₂, it has not received the preamble Pr and does not therefore respond. At the end of the time period Del, the node A has still not received any acknowledgement of receipt message on the main channel Ch₁. It therefore decides to retransmit the preamble Pr a second time on the main channel Ch_{P}. At the end of a number K of retransmissions, with K being an integer greater than or equal to 2, with no response on the main channel Ch_{P}, the node A decides to switch over to the secondary channel Ch₂.

In the example, K is chosen as equal to 2. At the end of the two retransmissions, the node A therefore transmits the preamble Pr on the channel Ch₂, then transmits the data frame Tr on the channel Ch_{T}. It then switches to standby awaiting a receipt message in the allowed time period Del.

The node B wakes up during the period of the preamble, listens to the channel Ch₂, detects the preamble and extends its wake period until it has received the complete preamble Pr. It then activates its radio reception means on the channel Ch_{T} in accordance with the transmission scheme agreed with the node A in order to receive the useful data frame Tr announced by the preamble Pr. At the end of this reception, it transmits an acknowledgement of receipt message Ack on the signaling channel Ch₂. The node A receives it in the allowed time period Del and terminates the communication signal transmission.

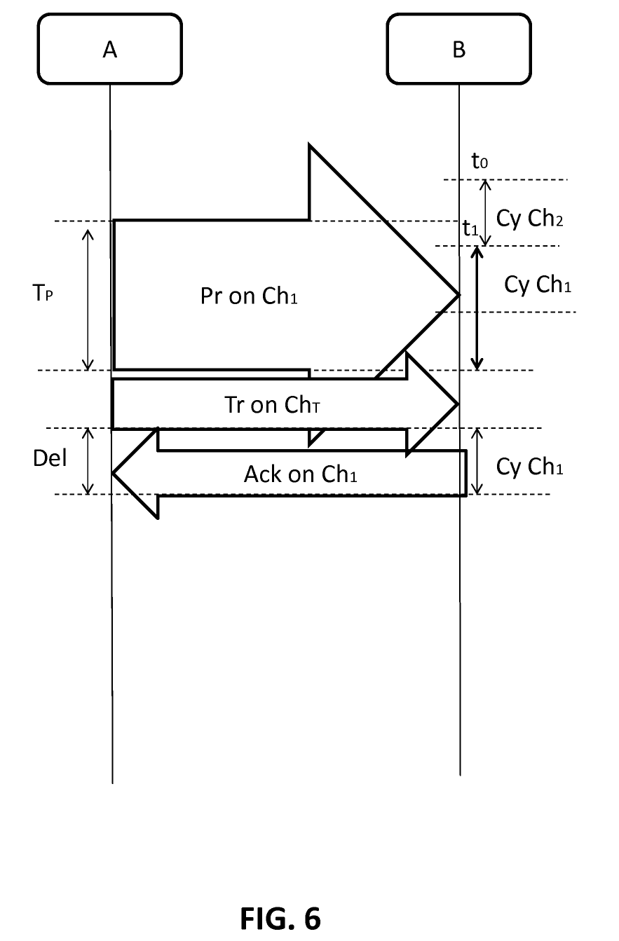

In relation to FIG. 6, a diagram is now shown of the flows exchanged between a transmitting node A and a receiving node B according to a second embodiment of the invention.

In this example, the nodes A and B operate according to a variant of the peer-to-peer exchange mode:
They have not preselected a main channel Ch_{P};
The node B listens alternately to the transmission channels Ch₁ and Ch₂ according to a period equal to a cycle Cy. With each new wake period, it therefore switches from one channel to the other.

It is assumed that the node A begins to transmit a preamble Pr on the channel Ch₁, whereas the node B has switched over to the channel Ch₂.

As discussed in relation to FIG. 4B, in order to ensure the reception of the preamble Pr by the node B, the node A must transmit a preamble with a duration T_{P} satisfying the following condition:

T_{P}≧N·(T_{S}+T_{W})

N is the number of transmission channels defined between the transmitting node and the receiving node, T_{S} is the sleep period and T_{W} is the wake period of the receiving node B.

In the example shown in FIG. 6, this condition is in fact satisfied in the case N=2. It is evident that, at the beginning of the transmission of the preamble, the node B has been in a cycle of listening to the channel Ch₂ since the time to. However, after a sleep period and before the end of the transmission of this preamble, it switches over to a period of listening to the channel Ch₁ at the time t₁. The node B is then able to receive the preamble Pr. On detection of a sufficient energy level received on the channel Ch₁, it activates its radio reception means and extends its wake period until the end of the transmission of this preamble. If, following the reception of the preamble Pr, the node B has established that the data were intended for it, it switches in R₄ to the channel Ch_{T}, defined according to the useful data transmission scheme agreed with the node A in order to receive the useful data frame Tr. At the end of this reception, it transmits an acknowledgement of receipt message to the node A on the channel Ch₁. Said node receives it in E5 and terminates the communication signal transmission procedure.

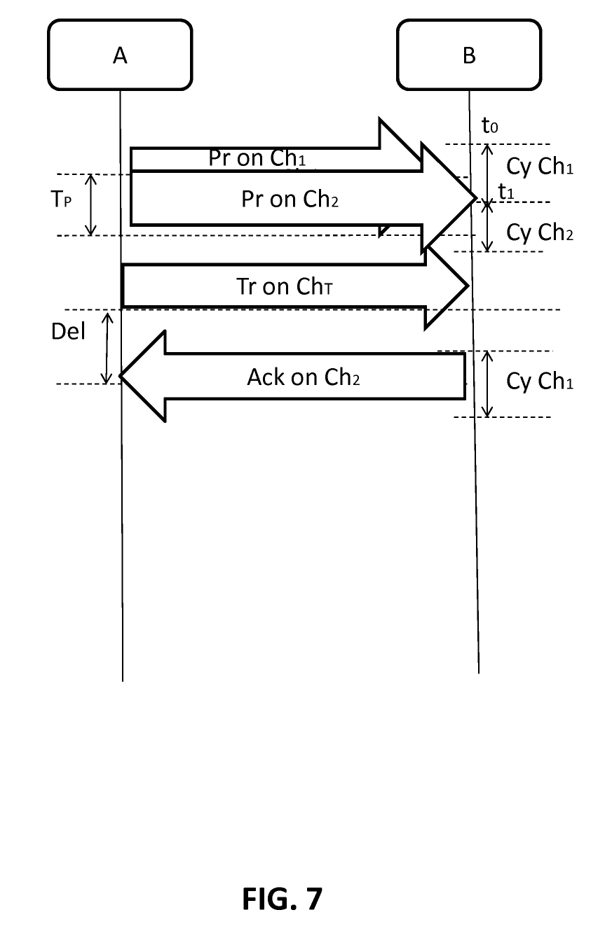

In relation to FIG. 7, a diagram is now shown of the flows exchanged between a transmitting node A and a receiving node B according to a third embodiment of the invention.

In this example, the nodes A and B operate according to a hierarchical mode. The node A is a concentrator node which has means for the simultaneous transmission of a preamble Pr on the N transmission channels.

It is assumed that the node B has selected, from the N transmission channels previously defined with the node A, a current signaling channel Chc, for example equal to Ch₁, to which it listens during its wake periods. It does not decide to change channels as long as the latter complies with its operating constraints, in particular as long as it does not produce a noise level greater than a predetermined noise threshold.

The node A therefore transmits the preamble Pr with a duration T_{P}>T_{S} simultaneously on the channels Ch₁ and Ch₂ from a time to. It is assumed that the node B is in a sleep period at this time.

The node B wakes up at the time to, during the transmission of the preamble on the channel Ch₁. It detects a sufficient energy level on the channel Ch₁, which activates its radio reception means, in R1. It remains awake until the end of the reception of the preamble Pr. Then, in accordance with the parameters of the received preamble, when the data are intended for it, it prepares for the reception of the useful data frame Tr on the transmission channel Ch_{T}. At the end of this transmission, it transmits an acknowledgement of receipt message Ack on the signaling channel Ch₁. It can then go back to sleep.

The node A receives the acknowledgement of receipt message Ack on the channel Ch₁ and terminates the procedure.

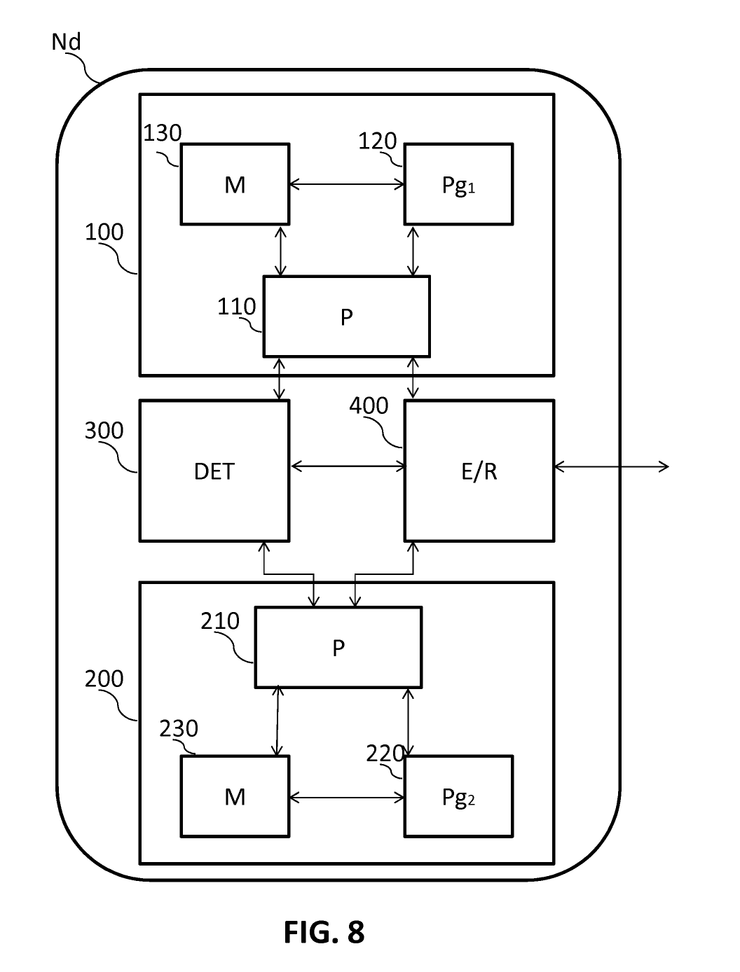

Finally, in relation to FIG. 8, the simplified structure of a node Nd is shown, including a reception processing device 100 and a transmission processing device 200 respectively carrying out a transmission method and a reception method according to one of the embodiments described above.

For example, the device 100 includes a processing unit 110, equipped, for example, with a processor P, and controlled by a computer program Pg₁ 120, stored in a memory 130 and carrying out the method for processing the reception of a communication signal according to the invention.

On initialization, the code instructions of the computer program Pg₁ 120 are, for example, loaded into a RAM memory before being run by the processor of the processing unit 110. The processor of the processing unit 110 carries out the steps of the previously described method for processing the reception of a communication signal, according to the instructions of the computer program 120.

The node Nd conventionally includes means 300 for detecting a quantity of energy received on the selected signaling channel, radio reception means 400 suitable for being activated when a sufficient quantity of energy has been received on the signaling channel. These means are controlled by the processor of the processing unit 110.

The processing unit 110 advantageously obtains information from such means relating to an energy level detected on the energy signaling channel or to a false detection. It uses said information, according to the instructions of the computer program Pg₁ 120, to carry out the steps of the method concerned, such as, for example, the step of detecting a triggering event such as the presence of a noise level greater than a predetermined noise threshold.

For example, the device 200 includes a processing unit 210, equipped, for example, with a processor P, and controlled by a computer program Pg₂ 220, stored in a memory 230 and carrying out the method for processing the reception of a communication signal according to the invention.

On initialization, the code instructions of the computer program Pg₂ 220 are, for example, loaded into a memory RAM before being run by the processor of the processing unit 210. The processor of the processing unit 210 carries out the steps of the previously described method for processing the transmission of a communication signal, according to the instructions of the computer program 220.

The means 300 for detecting a quantity of energy received on the selected signaling channel and the radio reception means 400 of the node N are controlled by the processor of the processing unit 210. The processing unit 210 receives information at its input from said means and it uses it, according to the instructions of the computer program Pg₂ 220, to carry out the steps of the method concerned for processing the transmission of a communication signal, for example during the step of detecting a triggering event linked to the presence of a noise level greater than a predetermined noise threshold.

The processing unit 210 advantageously receives information at its input from said means, for example information relating to the detected noise level.

At its output, it sends commands to said transmission/reception means 400, for example a command to change signaling channel Ch_{C} for the transmission of the preamble Pr on the current signaling channel Ch_{C} to the node B.

The invention is obviously not limited to the embodiments described. Other embodiments can be envisaged.

Although the present disclosure has been described with reference to one or more examples, workers skilled in the art will recognize that changes may be made in form and detail without departing from the scope of the disclosure and/or the appended claims.

1. A method comprising:
processing reception of a communication signal in a communication network including a plurality of nodes alternately observing sleep periods and wake periods, wherein a transmitting node causes transmission of data to a destination node to be preceded by a step of transmitting a preamble with a duration greater than a sleep period of the destination node, wherein a plurality of at least two transmission channels has been defined between the nodes with a view to transmitting said preamble, and wherein processing includes the following steps performed by a receiving node in the network:
selecting, from the plurality of channels, at least one preamble listening channel, referred to as a current channel; and
deciding to change listening channels from the plurality of transmission channels on detection of at least one triggering event likely to affect predetermined operating constraints of said receiving node.

2. The method for processing the reception of a communication signal as claimed in claim 1, wherein said at least one triggering event belongs to the group consisting of:
a noise level greater than a predetermined noise threshold;
a start of a new wake period.

3. The method for processing the reception of a communication signal as claimed in claim 2, wherein the method includes a step of determining a noise level, including the following steps:
receiving information relating to a detection of energy on the signaling channel, corresponding to a false detection of a communication signal;
counting a number of false detections by time unit; and
comparing the recorded number of false detections with said noise threshold level;
and wherein a triggering event is detected when said number of false detections is greater than said noise threshold.

4. The method for processing the reception of a communication signal as claimed in claim 2, wherein the receiving node and the destination node, have defined a main channel among the plurality of channels, and said main channel is selected as the preamble listening channel and the channel-changing step is initiated only if a noise level greater than the predetermined noise threshold is detected.

5. The method for processing the reception of a communication signal as claimed in 1 wherein a decision to change channels is triggered with each start of a new wake period, and the transmission channel is selected from the N transmission channels according to a predetermined listening order.

6. A device for processing reception of a communication signal in a communication network including a plurality of nodes alternately observing sleep periods and wake periods, a transmitting node causing transmission of data to a destination node to be preceded by a step of transmitting a preamble with a length at least equal to a sleep period of said destination node, wherein, a plurality of at least two transmission channels having been defined between the transmitting node and the destination node, and wherein said device comprises:
means for selecting, from the plurality of channels, at least one preamble listening channel, referred to as a current channel;
means for deciding to change listening channels from the plurality of transmission channels on detection of at least one triggering event likely to affect predetermined operating constraints of said receiving node.

7. A method comprising:
processing transmission of a communication signal in a communication network including a plurality of nodes alternately observing sleep periods and wake periods, wherein processing comprises the following steps performed by a transmitting node:
causing transmission of data to at least one destination node to be preceded by a step of transmitting a preamble with a length at least equal to a sleep period of the destination node, wherein a plurality N of at least two transmission channels have been defined between the transmitting node and said at least one destination node;
selecting, from the defined plurality of N transmission channels, at least one channel for transmitting said preamble, referred to as the current channel;
deciding to change transmission channels on detection of a transmission event likely to affect predetermined operating constraints of said transmitting node on said at least one current channel.

8. The method for processing the transmission of a communication signal as claimed in claim 7, wherein the transmission event belongs to the group consisting of:
an absence of reception of an acknowledgement of receipt message at the end of a predetermined number of retransmissions of said preamble on said channel;
a detection of a noise level greater than a second predetermined noise threshold.

9. The method for processing the transmission of a communication signal as claimed in claim 7, wherein the transmitting nodes, having previously defined a main transmission channel with the receiving node, selects the said main channel as the listening channel.

10. The method for processing the transmission of a communication signal as claimed in claim 7, wherein the selection step comprises selecting the plurality of transmission channels for a simultaneous transmission of the preamble on the plurality of channels and, on detection of a transmission event on one of said channels, the step of deciding to change channels decides to stop the transmission of the preamble on said channel.

11. A device for processing the transmission of a communication signal in a communication network including a plurality of nodes alternately observing sleep periods and wake periods, the device comprising:
means for causing the transmission of data from the transmitting node to a destination node to be preceded by a step of transmitting a preamble with a length at least equal to the sleep period of said destination node, a plurality N of at least two transmission channels having been defined between the transmitting node and said at least one destination node;
selecting, from the defined plurality of N transmission channels, at least one channel for transmitting said preamble, referred to as the current channel;
deciding to change transmission channels on detection of a triggering event on said at least one current channel.

12. (canceled)

13. (canceled)

14. A non-transitory computer-readable medium comprising a computer program stored thereon and including instructions for carrying out steps of a method for processing reception of a communication signal when this program is run by a processor, wherein the method comprises:
processing reception of the communication signal in a communication network including a plurality of nodes alternately observing sleep periods and wake periods, wherein a transmitting node causes transmission of data to a destination node to be preceded by a step of transmitting a preamble with a duration greater than a sleep period of the destination node, wherein a plurality of at least two transmission channels has been defined between the nodes with a view to transmitting said preamble, and wherein processing includes the following steps performed by a receiving node in the network:
selecting, from the plurality of channels, at least one preamble listening channel, referred to as a current channel; and
deciding to change listening channels from the plurality of transmission channels on detection of at least one triggering event likely to affect predetermined operating constraints of said receiving node.

15. A non-transitory computer-readable medium comprising a computer program stored thereon and including instructions for carrying out steps of a method for processing transmission of a communication signal when this program is run by a processor, wherein the method comprises:
processing transmission of a communication signal in a communication network including a plurality of nodes alternately observing sleep periods and wake periods, wherein processing comprises the following steps performed by a transmitting node:
causing transmission of data to at least one destination node to be preceded by a step of transmitting a preamble with a length at least equal to a sleep period of the destination node, wherein a plurality N of at least two transmission channels have been defined between the transmitting node and said at least one destination node;
selecting, from the defined plurality of N transmission channels, at least one channel for transmitting said preamble, referred to as the current channel;
deciding to change transmission channels on detection of a transmission event likely to affect predetermined operating constraints of said transmitting node on said at least one current channel.
